(19) United States
(12) Patent Application Publication
(10) Pub. No.: US 2015/0344164 A1
(43) Pub. Date: Dec. 3, 2015

(54) USE OF PLASTIC FILMS

(71) Applicant: IRPLAST S.p.A., Empoli (IT)

(72) Inventors: Carmelo DI COSTANZO, Chieti (IT); Gino PASQUINI, Chieti (IT); Angelo MONTAGANO, Chieti (IT); Giacomo SOLURI, Firenze (IT); Luca de BARTOLO, Mantua (IT); Fausto COSI, Firenze (IT)

(21) Appl. No.: 14/723,215

(22) Filed: May 27, 2015

(30) Foreign Application Priority Data
May 30, 2014 (IT) ML2014A001004

(51) Int. Cl. B65C 3/12; B29C 47/06; B29C 47/88; B29C 35/08; B29C 47/00; B29C 55/14

(52) U.S. Cl. CPC B65C 3/12; B29C 47/0057; B29C 55/143; B29C 47/8805; B29C 47/8895; B29C 35/0805; B29C 47/065; B29C 2035/0822; B29K 2023/12

(57) ABSTRACT

Use for preparing labels for “roll-fed” applications of a heat shrinkable uniaxial multilayer film, formed of at least three layers, wherein the core comprises a component a) selected from a1) isotactic crystalline polypropylene and/or a2) a crystalline copolymer of propylene with ethylene, and component b) selected from b1) amorphous atactic polypropylene and/or b2) an amorphous propylene-ethylene copolymer with at least one alpha-olefin having from 4 to 12 carbon atoms wherein, as % by weight with respect to the total amount of monomers, 1a; the total amount of additive component b), in parts by weight per 100 parts by weight of component a) being comprised between 3 and 12, the external skin layers comprise a copolymer of propylene with ethylene and at least one C₄-C₁₂ alpha-olefin, the film being obtained by simultaneous biaxial stretching by means of linear synchronous motors.

The present invention relates to the use of labels of plastic films for roll-fed application on containers having a circular horizontal section on high speed manufacturing lines, for example of the order of 8,000 packages/hour up to 75,000 packages/hour, preferably from 30,000 up to 60,000 and with a very low number of scraps on the application lines, ≦0.5%, preferably still more preferably ≦0.05%; the plastic film wound in rolls being obtained by a manufacturing process with improved film yields, the film yield being defined as the ratio by weight [(film produced wound in rolls)]/[raw materials used for film production].

These film rolls are also called extrusion mother rolls.

More in detail the present invention relates to labels for containers, preferably bottles, having the following characteristics: a variable diameter along the vertical axis, a convex lateral surface with different curvature radii in the zones of the container wherein the label is applied. More in detail, in correspondence of the zone of application of the upper edge (or upper side) of the label the curvature radius is higher than 74 mm, preferably higher than 75 mm, and in correspondence of the zone of application of the lower edge (or lower side) of the label higher than 72 mm, preferably higher than 73 mm. The label height, measured along the vertical axis of the bottle, is of about 60 mm, preferably about 55 mm; the distance between the lower edge of the label and the base of the container being about 12-14 mm.

The process of label application comprises the steps of cutting the labels from the film unwound from the roll, (the roll called also daughter roll, see below) and then coating the labels at register with adhesive along two bands perpendicular to the direction of the film unwinding. The adhesive used is an hot-melt adhesive that is made to adhere to the label by heating.

More specifically these plastic films have even very high lengths, higher than 1,000 meters, and are wound in rolls for easy industrial application.

The polypropylene labels at present available on the market for this application are obtained from sequentially stretched plastic films having a thickness of 40 μm and an heat shrinkage in MD of 22% that are subsequently wound in rolls.

From EP 1,074,593 in the name of the Applicant plastic film having adhesive bands are known, wherein the adhesive is applied transversally with respect to the direction of the tape unwinding. Said plastic film bands can be used to label containers.

In EP 1,862,518 in the name of the Applicant plastic film in rolls to be used in the high speed labelling processes, for example higher than 6,000 containers/hour up to 50,000 containers/hour, combined with scraps on the application lines lower than 2%, preferably lower than 1%, are described. The plastic film is made of heat shrinkable bioriented polypropylene polymers, with application of pressure sensitive adhesive according to transversal sectors with respect to the unwinding direction (i.e. longitudinal direction) of the film from the roll.

Patent application WO 96/2386 discloses multilayer heat shrinkable films wherein the core is based on an isotactic polypropylene homopolymer and on a modifier that reduces thereof crystallinity, such as for example atactic PP, syndiotactic PP, ethylene/propylene copolymers or LLDPE (linear low density polyethylene). The use of modifiers allows to increase heat shrinkage in MD direction.

Patent application EP 2,599,628 in the name of the Applicant describes the use of polyolefin-based films from rolls to prepare labels for roll-fed applications, to be used in high speed labelling machines, up to 75,000 containers/hour. The films, preferably multilayer films, have a thickness comprised between 14 μm to 20 μm, a flexural rigidity (N·mm) comprised between 0.5×10⁻² and 4.5×10⁻². The core is made of a propylene homopolymer containing extractables in n-hexane (50° C. for two hours) lower than 10%. The film is not heat shrinkable and shows a dimensional stability, determined according to OPMA TC 4 standard at 130° C. for 5 minutes in the air, in MD comprised between 0 and −10% and in TD between −4% and +4%.

There is a continuous need in the labelling industries to reduce the amount of plastic material used for producing labels due to environmental reasons. As a matter of fact efforts are undertaken to use a lower amount of plastic materials to reduce the energy consumption requested for label production. In this way the environmental sustainability is remarkably improved, as a lower amount of CO₂ is produced and therefore also a reduced greenhouse effect (GWP).

Furthermore at the end of their cycle of use, the labels must be disposed of. The market trend is to reduce the amount of packages and therefore also of labels to be recycled and/or disposed of. It is in fact well known that the disposal involves often high costs.

It should be considered that the transformation industries require to have available film rolls (called extrusion daughter rolls) having a length of the order of about 20,000 meters, from which to obtain printed and cut rolls having a maximum outer diameter of 600 mm for label roll-fed application. These are in fact the standard sizes requested in general for the labelling machines used at present.

The need was felt to use films to prepare labels for roll-fed applications for labelling containers having a circular horizontal section and a variable diameter along the vertical axis, said containers having a convex lateral surface and different curvature radii in the zones of the container wherein the label is applied: in the correspondence of the zone of application of the upper edge of the label the curvature radius is greater than 74 mm, preferably greater than 75 mm, and in the correspondence of the zone of application of the lower edge of the label the curvature radius is greater than 72 mm, preferably greater than 73 mm, the label height being about 60 mm, preferably about 55 mm, the distance between the lower edge of the label and the base of the container being 12-14 mm, the labelling machines working at a speed greater than 8,000 up to about 75,000 containers/hour, the films having a performance in label application comparable to the films available in the market for the same application, having for instance a thickness of 40 μm, see above, but with lower production costs with respect to the films at present used, that is with improved film yields, called also extrusion yields, greater than 95%, reaching also 96%, the film yields being defined as the ratio by weight [film produced wound in rolls]/[raw materials used for film production].

The solution found by the Applicant to the above technical problem is as hereinafter indicated.

It is an object of the present invention the use for preparing labels for roll-fed applications of an uniaxial heat shrinkable multilayer film, comprising at least three layers, wherein:

the core comprises
component a) selected from
a1) isotactic crystalline polypropylene homopolymer and/or
a2) a crystalline copolymer of propylene with ethylene, optionally containing an alpha-olefin and
component b) selected from
b1) amorphous atactic polypropylene and/or
b2) an amorphous propylene-ethylene copolymer with at least one alpha-olefin having from 4 to 12 carbon atoms wherein, as % by weight with respect to the total amount of monomers, the total amount of ethylene plus alpha-olefin is comprised between 1 and 15%, ethylene between 0 and 10%, the alpha-olefin between 1 and 15%;
the total amount of additive component b), i.e. b1)+b2), in parts by weight per 100 parts by weight of component a) (a1) and/or a2)) being comprised between 3 and 12, the amount (parts by weight) of component b1) is comprised between 0 and 12, that of component b2) is comprised between 0 and 12;
the skin layers (or external layers) comprise a copolymer of propylene with ethylene and at least one C₄-C₁₂ alpha-olefin wherein, as % by weight with respect to the total amount of the monomers, the amount of ethylene plus alpha-olefin is comprised between 6 and 25%, ethylene being between 1 and 5%, the alpha-olefin between 5 and 25%;
   the film obtainable by simultaneous biaxial stretching by means of linear synchronous motors, the heat shrinking in MD being comprised between 8 and 17% and in TD these values determined by the heat shrinking test OPMA TC 4 (Oriented Polypropylene Manufacturers' Association) (130° C.-5 minutes in the air);
   the thickness of the multilayer film being comprised between 25 and 35 μm; the thickness of each skin layer being in the range from 0.5 to 1.5 μm;
   the film yield, defined as the ratio by weight between [film produced wound in rolls]/[raw materials used for film production], being ≧95%;
   as said above, these rolls are called extrusion mother rolls;
   the scraps on the line of label application to the containers 0.5%;
   wherein the label application process on the containers comprises the following steps:
unroll in MD direction of the multilayer plastic film roll;
slit to size of the film for obtaining labels;
application of hot melt adhesive bands on the side of the label facing the container, in the correspondence, respectively, of the leading edge and of the trailing edge of the label in MD direction, said adhesive bands being parallel to the vertical axis of the container, the container having a convex lateral surface and a circular horizontal section with a diameter variable along the vertical axis,
application of the adhesivized label on the container convex lateral surface having a curvature radius greater than 74 mm in the correspondence of the zone wherein the upper edge of the label is applied, and greater than 72 mm in the correspondence of the zone wherein the lower edge of the label is applied; the label height, determined along the vertical axis of the container, being 60 mm and the distance between the lower edge of the label and the base of the container being 12-14 mm, the hot-melt adhesive being activated by means of a heat supplying device;
label heat shrinking by passing the labelled container in a heat shrink tunnel at a temperature from 60° C. to 300° C., thus obtaining a labelling adherent to the container that conforms to the convex lateral surface of the container;
   the label application line working at a speed from 8,000 up to 75,000 containers/hour.

The lower edge of the label is the edge near to the base of the container.

Preferably the multilayer film of the invention has three layers.

Preferably as component a) isotactic polypropylene component a1) and as component b) amorphous atactic polypropylene component b1) are used.

The determination of the amount of isotactic polypropylene component a1) in admixture with the amorphous atactic component b1) (isotactic index) is carried out by extracting the sample with n-hexane under reflux, as indicated in the part “characterization” of the examples.

Generally the isotactic index of the polypropylene homopolymer component a1) of the core is comprised between 92 and 98, i.e. the amount of atactic polymer (amorphous) is generally comprised between 2 and 8%.

The propylene-ethylene copolymer component a2) of the core has an ethylene content (% by weight) comprised between 0.3% and 10%, preferably between 0.5 and 5%, more preferably 0.6 and 2%; the optional alpha-olefin ranging from 0 to 20%.

The copolymer a2), together with a crystalline part, may contain also an amorphous part. The amount of the amorphous part is determined by extraction of the polymer with xylene, as indicated in the method described under “characterization” of the examples.

Preferably in the propylene-ethylene-alpha-olefin copolymer component b2) the total amount of comonomers, as % by weight on the total monomer amount, is comprised between 2 and

10%, more preferably from 3 to 7%, the ethylene amount ranges from 1 to 5% by weight, the alpha-olefin preferably has from 4 to 8 carbon atoms and the amount of alpha-olefin is comprised between 2 and 10%, more preferably 3-5% by weight on the total monomer weight.

Preferably the amount of additive component b), as parts by weight/100 parts by weight component a), is comprised between 4 and 10, more preferably between 5-8.

In the propylene copolymer of the skin layers the alpha olefin has a chain length preferably from 4 to 8 carbon atoms.

The preferred alpha-olefins of the copolymers a2) and b2) and of the copolymers of the skin layers are selected from butene, hexene and octene, more preferably butene.

The external layers of the multilayer film can be the same or different, both as regards to the composition and relevant thickness, preferably they are the same. One of the skin layers is preferably surface treated, for example corona, flame plasma, etc. to make easier a good anchorage to the film of the printing inks and of the adhesive.

The external layers can comprise optional components selected from slip agents, anti-blocking agents, opacifiers. The core can optionally comprise antistatic agents, dyestuffs, etc.

When a greater covering effect (greater optical density and a lower transmittance of the film) is needed, a dyestuff made of a TiO₂-based master-batch can be used for providing white films printable from the outside.

As slip agents amides of higher aliphatic acids, esters of higher aliphatic acids, waxes, salts of fatty acids with metals and polydimethyl siloxanes can be mentioned. Thereof used amount is that conventional in the plastic films of the art.

As antiblocking agents inorganic compounds, such as silicon dioxide, clays, talc, calcium carbonate and the like, preferably available in the form of spheroidal-like particles, can be mentioned. As antiblocking agents amorphous silicone resins, for example crosslinked polysiloxanes substituted with hydrocarbons, more in detail polymonoalkyl-siloxanes having average particle diameter comprised between 0.5 and 20.0 μm and a tridimensional structure of the siloxane bonds, can be cited.

The relevant amount is generally comprised between about 0.1 and about 0.5% by weight referred to the weight of the external layer.

As antistatic agents aliphatic tertiary amines with saturated linear chains containing a C₁₀-C₂₀ aliphatic radical and substituted with ω-hydroxy-(C₁-C₄)alkyl groups, can be mentioned. Among tertiary amines N,N-bis(2-hydroxyethyl)alkylamines containing C₁₀-C₂₀, preferably C₁₂-C₁₈ alkyl groups, can be in particular mentioned. The amount of antistatic agent is generally comprised from about 0.05% to about 0.2% with respect to the weight of the layer.

The heat shrinkage of the uniaxial film of the invention in MD is preferably comprised between 10 and 14% and in TD≦1%

Generally for labels heat shrink values very low in TD are preferred in order to obtain a label with dimensional stability in transversal direction.

Preferably the curvature radius of the surface of the container to be labelled in the correspondence of the zone of application of the upper edge of the label is greater than 75 mm and that in the correspondence of the zone of application of the lower edge of the label is greater than 73 mm.

Preferably the label height is 55 mm.

Preferably the thickness of the multilayer film is comprised between 28 and 32 μm, more preferably it is of about 30 μm. Preferably the thickness of each of the skin layers ranges from 0.6 to 1 μm.

Preferably the film yield of the process of production is ≧96%. The increase of film yield with respect to the films used in the prior art for the same application and having a thickness of 40 μm is of the order ≧0.5%, but it can also arrive to 1.5%.

This means that the hourly production of the film of the present invention is quite higher with respect to the prior art films, even considering yearly productions ranging only from 2,500 up to 4,000 tons. Therefore if a production increase from ≧0.5% up to 1.5% is obtained, this means on a year base that from 12.5 up to 40 tons more of the film can be produced. From an industrial point of view this represents a desired target for the labelling industries. If the yearly productions further increase, the increases in productivity are even higher.

The scraps on the line of label application to the containers are preferably ≦0.1%, more preferably ≦0.05%.

These scraps are defined as the ratio between the number of containers affixed with defective labels/number of total labelled containers produced.

It has been unexpectedly and surprisingly found that the labels of the uniaxial multilayer films of the present invention allow to obtain a low number of scraps during the application step. It has been found by the Applicant that the labels conform very well to the shape of the containers as defined above. In fact those defects occurring during label application such as for example wrinking, folding, creasing, curling, surprisingly and unexpectedly, result substantially absent in the application of the labels according to the present invention.

It has been unexpectedly and surprisingly found by the Applicant that although the flexural rigidity (N·mm) as defined later on under “Characterization” is lower compared with the commercial films having a thickness of 40 μm, during label application the films according to the present invention do not produce a higher number of scraps with respect to those obtained with the above 40 μm films. See the examples.

Preferably the temperature in the heat shrinking apparatus, for example an oven, ranges from 150° C. to 210° C. The time of exposure of the containers to these temperatures preferably ranges from 1 to 3 seconds, preferably from 1 to 2 seconds.

The multilayer plastic films of the present invention have a density comprised between 0.850 and 0.950 g/cm³.

The multilayer films are also endowed of good mechanical properties as shown by the tensile properties such as tensile strength at break, elongation at break and modulus measured according to ASTM D 882, and tearing resistance. The optical properties of the multilayer films of the present invention are particularly good, as shown by the gloss values and in particular the haze values.

As said, the multilayer films of the invention are obtainable with a process comprising coextrusion of the core and skin layers starting from the polymer granules, the films obtained by coextrusion are then biaxially oriented, as described further on. The films, having very high lengths, even of the order of 20,000 meters, are then wound in rolls. These rolls are called extrusion mother rolls (neutral film) and have a diameter up to 1000 mm and a width generally up to 6,000 mm. By cutting these rolls, the extrusion daughter rolls are obtained (neutral film), having preferably the same diameter as the extrusion mother rolls but a lower width from 400 to 1,500 mm.

In the subsequent transformation step the extrusion daughter rolls, (called in this step transformation mother rolls) are printed and cut to yield the rolls for the end use.

The process for producing the multilayer film of the present invention comprises a modulatable simultaneous horizontal stretching process carried out with the apparatus and technology as described in the basic patents U.S. Pat. No. 4,853,602 and U.S. Pat. No. 5,051,225, herein incorporated by reference, and subsequent patents describing this technology.

The process for producing the multilayer film comprises the following steps:
coextrusion of a multilayer plate, having a thickness preferably comprised from about 0.5 mm to about 4 mm, on a flat extrusion head;
cooling of the plate on the surface of a chill roll cooled by dipping in a water bath, at a temperature preferably from 5 to 35° C.;
plate heating preferably by an infrared ray unit wherein the temperature of the IR panel surface ranges from about 100° to about 500° C., preferably this step is carried out by using infrared rays;
stretching and orientation of the plate by a simultaneous orientation process, by holding the edges of the plate, having an higher thickness than the plate, with a series of pliers or clamps independently driven by linear synchronous induction motors, the set of pliers/clamps sliding on divergent stretching tracks; the linear synchronous induction motors are fed with alternate currents, thereof phases and frequencies being modulated so that the pliers/clamps follow a pre-programmed linear speed profile in order to obtain the requested stretching ratios in MD; wherein the MD stretching ratios are a function of the linear longitudinal speed profile and the TD stretching ratios are regulated by the distance/divergence between the stretching rails;
the stretching frame comprises one or more sections inside an oven wherein temperatures are preferably comprised from about 145° to 175° C.;
the MD longitudinal stretching ratios being comprised from about 4:1 to about 9:1 and the TD transversal stretching ratios from about 3:1 to about 8:1.
final heat setting in TD carried out by converging the stretching rails in one or more sections of the stretching frame, the temperatures of this step being comprised between about 135° C. and 160° C.

In a first approximation, the longitudinal stretching ratio can be considered equal to the ratio between the film speed at the outlet from the stretching frame and its inletting speed into the frame. In relation to the set up of the stretching apparatus, this ratio is equivalent to the ratio between the frequency of the alternate current fed to the linear electric motors at the outlet of the stretching frame and the frequency of the alternate current fed to the linear motors at the inlet of the stretching frame. Preferably the MD longitudinal stretching ratios are comprised between about 5.5:1 and 7:1.

The transversal stretching ratio can be considered in a first approximation equal to the ratio between the width of the film at the outlet of the stretching frame and the width of the film at the inlet of the stretching frame.

It is another object of the present invention a process for the application on containers of the labels of the plastic films of the present invention comprising the following steps:
unroll in MD of the multilayer plastic film roll;
slit to size of the film for obtaining labels;
application of hot melt adhesive bands on the side of the label facing the container, in correspondence, respectively, of the leading edge and of the trailing edge of the label in MD, said adhesive bands being parallel to the vertical axis of the container, the container having a convex lateral surface and a circular horizontal section with a diameter variable along the vertical axis,
application of the adhesivized label on the convex lateral surface of the container having a curvature radius greater than 74 mm in the correspondence of the zone wherein the upper edge of the label is applied and greater than 72 mm in the correspondence of the zone wherein the lower edge of the label is applied; the label height, determined along the vertical axis of the container being 60 mm and the distance between the lower edge of the label and the base of the container being 12-14 mm, the hot-melt adhesive being activated by means of a heat supplying device;
label heat shrinking by passing the labelled container in a heat shrink tunnel at a temperature from 60° C. to 300° C., obtaining an adherent labelling to the container that conforms to the convex lateral surface of the container; the label application line working at a speed from 8,000 up to 75,000 containers/hour.

The multilayer film of the invention is supplied in rolls for direct industrial application, the so called roll fed application.

It has been unexpectedly and surprisingly found that by using conventional labelling machines for high speed applications, the multilayer films of the present invention are very fast unrolled from the rolls without jamming on the labelling line.

The labels are obtained by cutting the printed multilayer film unwound from the rolls, on the roll-fed line.

The length of the adhesivized part of the label, determined in the longitudinal direction (MD) of the tape is generally lower than or equal to 25%, preferably lower than or equal to 15% with respect to the total length of the label. The cut pitch of the label is preferably comprised between about 10 cm and 1 m in MD.

It is to be noted that the production of these films is remarkably advantageous compared with that of the films having a thickness of 40 μm described in the prior art for the same applications. As a matter of facts these films are generally obtained by sequential stretching in MD and then in TD, followed by a final stretching in MD.

Unexpectedly and surprisingly by using the simultaneous stretching LISIM machines, the amount of energy used for producing the multilayer films of the present invention is lower than that requested for producing the prior art films having 40 μm thickness. This is a remarkable advantage from an industrial point of view, as the Applicant has made available to the application industries rolls made of a film that, the weight being equal, allow to produce a higher number of labels than with the above prior art films, and besides by using a process requesting less energy, although maintaining the scraps in application at very low levels, comparable to that of the 40 μm films but with improved film yields, in particular for film production campaign of the order of 50-100 tons.

The labelled containers, for example bottles, obtainable with the roll-fed process of the invention meet the specifications requested by customers. In particular, as said, the heat shrunk label conforms completely and uniformly to the bottle shape. Furthermore, on the part of the label corresponding to the overlap of the two vertical edges there are no defects, due, for instance, to local unsticking and consequent film partial lifting, or folding caused by the adhesive.

The Applicant points out that with the films of the present invention remarkable advantages from an industrial point of view are obtained, as the rolls of the films of the present invention for use in roll-fed application having a same diameter of the rolls of commercial films having 40 μm thickness, allow to obtain a lower impact on transport and storage costs and also on production costs.

As the length of the film unwound from rolls having the same external diameter in the case of the films of the present invention is higher than for the prior art films (see above). Therefore on the labelling lines the roll substitution steps are reduced and there are fewer machine stops and consequently higher yields are obtained.

The following Examples are given for illustrative and not limitative purposes of the present invention.

### EXAMPLES

### Characterization

### Determination of the Isotactic Polypropylene Content in Polypropylene (Isotacticity Index)

The determination of the isotactic polypropylene in admixture with the amorphous portion is carried out by extracting for two hours the sample with n-hexane at 50° C. according to FDA 177 1520 Standard. The insoluble fraction is recovered and weighed. The isotactic index is given by the formula:

weight of the insoluble fraction in hexane×100 Sample weight

### Determination of the Soluble Fraction in Xylene of the Propylene Copolymers

2 g of polymer are dissolved in 250 cm³ of xylene at 135° C. under stirring. After 20 minutes the solution is allowed cool, while continuing stirring, down to the temperature of 25° C. After 30 minutes the mixture is filtered and the solid is separated from the organic solvent. The solvent is removed by evaporation in a nitrogen stream. The obtained residue is dried under vacuum at 80° C. up to a constant weight. The weight residue corresponds to the amount of the soluble fraction of the propylene copolymer in xylene (amorphous fraction). The weight multiplied by 100 and divided by the starting polymer weight (2 g) gives the percentage of the amorphous part of the polymer.

By using this same calculation and substituting to the weight of the soluble fraction in xylene that of the solid recovered by the first filtration and dried, the percentage of the crystalline part of the polymer is obtained.

### Melt Flow Index (MFI)

The melt flow index was determined at 230° C. for 10 min with a 2.16 Kg load according to ISO 1133.

### Determination of the Film Heat Shrink

The film heat shrink is determined according to OPMA TC 4 standard by heating a sample 20 cm×1 cm at 130° C. per 5 minutes in the air.

The heat shrink in MD or in TD is calculated with the following formula:

$$\frac{( {L}_{1} - {L}_{2} ) \times 100}{{L}_{1}}$$

wherein:
L₁ is the film length before the heat treatment,
L₂ is the film length after heat treatment.

Heat shrinking can also be indicated with the number obtained with the above formula preceded by a negative sign−.

If the label dilates by heating, the dilation values in MD or in TD, preceded by a positive sign+, are determined by the following formula:

$$\frac{( {L}_{2} - {L}_{1} ) \times 100}{{L}_{1}}$$

wherein L₁ and L₂ have the above mentioned meanings.

### Young Modulus (Elastic Modulus)

The Young modulus, or elastic modulus (N/mm²) has been determined according to ASTM D 882 standard both in MD direction and in TD direction. The modulus is determined on a film sample of the extrusion mother roll (t=0) and the determination repeated after 48 hours.

### Elongation at Break and Tensile Strength at Break

The elongation at break and tensile strength at break of the film have been determined according to ASTM D 882.

### Flexural Rigidity

The flexural rigidity, or rigidity (N·mm), is given by the following formula:

R=[E·d³]/12(1−v²)

wherein R is the rigidity, E the Young modulus and d is the thickness in mm. In the flexural rigidity calculation v² can also be omitted as it reduces to a very small number.

### Haze

The Haze values were determined according to ASTM D 1003.

### Gloss

Gloss was determined according to the ASTM D 2457 standard.

### Determination of the Film Yield

The film yield was determined according to the following formula:

$$\frac{P 2 \times 100}{P 1}$$

wherein:
P1 is the weight of the starting polymeric material
P2 is the weight of the obtained film.

### Determination of the Friction Coefficient (COF)

The friction coefficient was determined by ASTM D 1894 method.

### Determination of Scraps During Application

The % scraps in application were determined as the ratio [number of containers with defective labels]/[number total labelled containers]. Defective labels are those labels showing, for example, wrinkling, folding, creasing, curling or when in the part corresponding to the overlapping of the two label edges local unsticking with consequent partial film lifting occurs.

### Example 1

The film was obtained by coextruding through a flat die three polymeric layers corresponding to a core layer and to two skin layers wherein, respectively, the composition of the core and of the skin layers was the following:

### The Core Layer:

95% by weight of isotactic propylene homopolymer with isotacticity index 95%, and
5% of a propylene-ethylene-butene elastomeric copolymer, wherein, as % by weight based on the total weight of the monomers, the amount of ethylene and butene is 12%, ethylene 4% and butene 8%.

The external layers were made of heat sealable random ethylene/propylene/butene terpolymers, wherein the sum of the two comonomers of the terpolymers, expressed as % by weight with respect to the total weight of the monomers, is 9%.

The core polymer and the polymers of the external layers were coextruded to obtain a final plate wherein the core polymer formed the central layer and the polymers of the external layers form the skin layers. The temperature of the flat extrusion die was 245° C. The so obtained plate was cooled on a chill roll kept at a temperature of 30° C. by fluxing water into the interspace of the chill roll, which was dipped in a water bath having the temperature of 35° C. The chilled plate was transferred into an infrared heating battery wherein the temperature of the heating panel surface was comprised between 230° C. and 400° C. Then the plate entered a simultaneous stretching oven Lisim®, equipped with linear synchronous motors wherein the temperature values being as it follows:

In the preheating zone: 171° C.;

In the stretching zone: from 153° C. up to 149° C.;

In the stabilization zone in TD (annealing step in TD): from 155° C. to 140° C.;

The MD and TD stretching ratios were respectively 6.3:1 (MD) and 6.2:1 (TD). One surface of the obtained film was subjected to flame treatment. The value of the surface tension ≧44 dyne/cm.

The film thickness was of 29.96 μm, the thickness of the central layer 28.54 μm and of each of the two skin layers 0.71 μm.

In the campaign 100 tons of film were produced. In a campaign even up to 200 ton film can be produced.

The film yield was 95.4%.

The mechanical, optical and shrinking properties in MD/TD are reported in Table 1.

The film was then wound in rolls.

### Example 2

### Comparative

This Example has been devised by the Applicant, but it is not described in the prior art.

Example 1 was repeated to prepare a film having thickness of 40 μm, by coextruding through a flat heat three polymeric layers wherein, respectively, the composition of the core and of the skin layers was equal to that of the film of example 1.

The core polymer and the polymers of the skin layers were coextruded through a flat die at a temperature of 245° C. The plate was then chilled and in the next step heated as in Example 1. Then the plate underwent a simultaneous stretching by inletting a Lisim® oven apparatus equipped with linear synchronous motors wherein the temperatures were as it follows:

In the preheating zone: as in Example 1;

In the stretching zone: from 151° C. up to 147° C.;

In the stabilization zone in TD (annealing): from 147° C. to 131° C.;

the MD and TD stretching ratios are the same as in Example 1. One surface of the so obtained film was subjected to flame treatment, the value of the surface tension was >44 dyne/cm.

The film thickness was of 39.71 μm, the thickness of the central layer being of 38.27 μm and of each of the skin layers 0.72 μm.

In the campaign 100 tons of film were produced.

The film yield is 94.8%.

The mechanical, optical and shrinking properties in MD/TD are reported in Table 1.

### Comments

The data reported in Table 1 show that the flexural rigidity of the film of Example 1 according to the present invention is lower than the film of Example 2 comparative. Furthermore it is observed that the Haze value is improved in the film of Example 1 with respect to that of the comparative Example.

### Example 3

Example 1 was repeated but using a core made of isotactic polypropylene having an isotacticity index of 94% (atactic 6%) for preparing a film having thickness 32 μm.

The outer layers had the same composition of the corresponding layers of the film of example 1.

The core polymer and the polymers of the skin layers were coextruded through a flat die at a temperature of 245° C. to form a plate with three layers (core and skin layers), the outer layers are the skin layers. The so obtained plate was chilled and then heated again as described in Example 1. Then the plate entered the simultaneous stretching machine Lisim®, equipped with linear synchronous motors wherein the temperatures of the preheating zone, of the stretching zone and of the stabilization zone in TD were as in Example 1. The same MD and TD stretching ratios used of Example 1 have been used in the simultaneous stretching step. One surface of the so obtained film underwent a flame treatment. The value of the surface tension was >44 dyne/cm.

The film thickness was of 32 μm.

The thickness of the central layer was 30.4 μm and of each of the skin layers 0.8 μm.

The film yield resulted comparable with that obtained in Example 1.

TABLE 1

| Properties | Ex. 1 | Ex. 2 comp |
|---|---|---|
| Haze (%) | 1.55 | 2.14 |
| Gloss | 89 | 86 |
| Tensile strength at break MD (N/mm²) | 174 | 176 |
| Tensile strength at break TD (N/mm²) | 192 | 206 |
| Elongation at break MD (%) | 95 | 92 |
| Elongation at break TD (%) | 92 | 81 |
| Elastic modulus MD at t = 48 h (N/mm²) | 2896 | 2454 |
| Flexural rigidity (×10⁻²) (n · mm) | 7.8 | 15.4 |
| Elastic modulus TD a t = 48 h (N/mm²) | 2812 | 2539 |
| Shrinking MD (%) 135° C./7 min | −16.55 | −23.01 |
| Shrinking TD (%) 135° C./7 min | 0.75 | −2.84 |

### Application Examples

### Example 4

The film roll of example 1 was used. On the application line the film was unwound and cut to form labels having 55 mm height (TD direction) and 144 mm length (MD direction). On the label two hot melt adhesive bands were applied in correspondence of the leading and trailing edge with respect to the unwinding direction in MD of the roll. The containers to be labelled were bottles of 100 ml volume having a circular section on an horizontal plane and a variable diameter along their vertical axis, the maximum diameter being of 43.7 mm. The containers have a convex shape in the zone of the label application; in particular in the zone wherein the upper edge of the label is applied, the curvature radius is 75 mm and of 73.7 mm in the zone of application of the lower edge of the label. The distance between the lower edge of the label and the base of the container is 12.5 mm. Line speed was 55,000 bottles/hour.

Label heat shrinking after application to the containers was carried out into a heat shrinking device wherein the temperature was kept in the range from 200 to 167° C. The time of exposure of each container at these temperatures was 1.5 seconds.

The application line operated for 3 hours. The percentage of scraps was lower than 0.1%. It was noted that the labels were perfectly slit and did not show defects as wrinkling, creasing, folding, curling, local unsticking or partial lifting of the film in the part corresponding to the overlapping of the two label (vertical) edges.

### Example 5

### Comparative

Example 4 was repeated but using the film of Example 2 comparative.

The obtained results overlapped those of Example 4 However it is to be noted that this film yield was lower than in Example 4.

### Example 6

Example 4 was repeated but using the film of Example 3. Scraps were about 0.2%.

1. Use for preparing labels for “roll-fed” applications
of an uniaxial heat shrinkable multilayer film, comprising at least three layers, wherein:
the core comprises
component a) selected from
a1) isotactic crystalline polypropylene and/or
a2) a crystalline copolymer of propylene with
ethylene, optionally containing an alpha-olefin and
component b) selected from
b1) amorphous atactic polypropylene and/or
b2) an amorphous propylene-ethylene copolymer with at least one alpha-olefin having from 4 to 12 carbon atoms wherein, as % by weight with respect to the total amount of monomers, the amount of ethylene plus alpha-olefin is comprised between 1 and 15%, ethylene between 0 and 10%, alpha-olefin between 1 and 15%;
the amount of additive component b), b1)+b2) in parts by weight per 100 parts by weight of component a) being comprised between 3 and 12, the amount (parts by weight) of component b1) is comprised between 0 and 12, that of component b2) is comprised between 0 and 12;
the skin layers comprise a copolymer of propylene with ethylene and at least one C₄-C₁₂ alpha-olefin wherein, as % by weight with respect to the
amount of the monomers, the amount of ethylene plus alpha-olefin is comprised between 6 and 25%, ethylene being between 1 and 5%, the alpha-olefin between 5 and 25%;
the film obtainable by simultaneous biaxial stretching by means of linear synchronous motors, the heat shrinking in MD being comprised between 8 and 17% and in TD≦2, these values determined by the heat
shrinking test OPMA TC 4 (Oriented Polypropylene Manufacturers' Association) (130° C.—5 minutes in the air);
the thickness of the multilayer film being comprised between 25 and 35 μm;
the thickness of each skin layer being in the range from 0.5 to 1.5 μm;
the film yield, defined as the ratio between [weight of film produced wound in rolls]/[weight of the raw materials used for film production] being ≧95%;
the scraps on label application line ≦0.5%;
wherein the label application process on the containers comprises the following steps:
unroll in MD direction of the multilayer plastic
film roll;
slit to size of the film for obtaining labels;
application of hot melt adhesive on the side of the label facing the container, in the correspondence, respectively, of the leading edge and of the trailing edge of the label in MD direction, the container having a convex lateral surface and a circular horizontal section with a diameter variable along the vertical axis,
application of the adhesivized label on the container convex lateral surface having a curvature radius greater than 74 mm in the correspondence of the zone wherein the upper edge of the label is applied and greater than 72 mm in the correspondence of the zone wherein the lower edge of the label is applied, the label height, determined along the vertical axis of the container, being 60 mm and the distance between the lower edge of the label and the base of the container being 12-14 mm, the hot-melt adhesive being activated by means of a heat supplying device;
label heat shrinking by passing the labelled container in a heat shrink tunnel at temperature from 60° to 300° C., thus obtaining a labelling
adherent to the container and conforming to the convex lateral surface of the container;
the label application line working at a speed from 8,000 up to 75,000 containers/hour.

2. Use according to claim 1 wherein the film comprises three layers.

3. Use according to claim 1 wherein as component a) isotactic crystalline polypropylene component a1) is used.

4. Use according to claim 3 wherein as component b) amorphous atactic polypropylene component b1) is used.

5. Use according to claim 1 wherein the propylene-ethylene copolymer component a2) of the core has an ethylene content (% by weight) comprised between 0.3% and 10%, the optional alpha-olefin ranging from 0 to 20%.

6. Use according to claim 1 wherein in component b2) the amount of comonomers as % by weight on the total monomer amount is comprised between 2 and 10%, the ethylene amount between 1 and 5%, the alpha-olefin has from 4 to 8 carbon atoms and the alpha-olefin amount ranges from 2 to 10%.

7. Use according to claim 1 wherein the amount of additive component b) in the core, expressed as parts by weight/100 parts by weight component a), is comprised between 4 and 10.

8. Use according to claim 1 wherein in the propylene copolymer of the skin layers the alpha olefin has from 4 to 8 carbon atoms.

9. Use according to claim 1 wherein the alpha-olefins of the copolymers a2) and b2) of the core and of the copolymers of the skin layers are selected from butene, hexene and octene.

10. Use according to claim 1 wherein the external layers are equal to each other.

11. Use according to claim 1 wherein one of the external layers is surface treated.

12. Use according to claim 11 wherein the skin layers comprise optional components selected from slip agents, anti-blocking agents, opacifiers are present, in the core antistatic agents, dyestuffs.

13. Use according to claim 1 wherein the heat shrinkage of the film in MD is comprised between 10 and 14% and in TD≦1%.

14. Use according to claim 1 wherein the curvature radius of the lateral surface of the container in the correspondence of the zone wherein the upper edge of the label is applied is higher than 75 mm and in the correspondence of the zone wherein the lower edge of the label is applied is higher than 73 mm.

15. Use according to claim 1 wherein the thickness of the multilayer film is comprised between 28 and 32 μm.

16. Use according to claim 1 wherein the thickness of the multilayer film is of about 30 μm.

17. Use according to claim 1 wherein the scraps on the label application line are ≦0.1%.

18. A process for producing the multilayer film of claim 1 comprising the following steps:
coextrusion of a multilayer plate, having a thickness comprised between about 0.5 mm and about 4 mm, on a flat extrusion head;
cooling of the plate on the surface of a chill roll cooled by dipping it in a water bath, at a temperature from 5 to 35° C.;
plate heating preferably by an infrared ray unit wherein the temperature of the surface of IR panels ranges from about 100° to about 500°.
stretching and orientation of the plate by a simultaneous orientation process by holding the edges of the plate, having an higher thickness than the plate, with a series of pliers or clamps independently driven by linear synchronous induction motors, the set of pliers/clamps sliding on divergent stretching rails; the linear synchronous induction motors are fed with alternate currents, thereof phases and frequencies being modulated so that the pliers/clamps follow a pre-programmed linear speed profile in order to obtain the requested stretching ratios in MD;
wherein the MD stretching ratios are a function of the linear longitudinal speed profile and the TD stretching ratios are regulated by the distance/divergence between the stretching rails;
the stretching frame used for the film stretching steps comprises one or more sections in-side an oven having temperatures comprised between about 145° C. and 175° C.;
the MD longitudinal stretching ratios being comprised from about 4:1 to about 9:1 and the TD transversal stretching ratios from about 3:1 to about 8:1.
final heat setting in TD carried out by converging the stretching rails in one or more sections of the stretching frame at temperatures of about 135° C.-160° C.

19. Process according to claim 18 wherein the MD stretching ratios are comprised from about 5.5:1 to 7:1.

20. A process for the application on containers of the labels of the plastic films of claim 1 comprising the following steps:
unroll in MD the multilayer plastic film roll;
slit to size of the film for obtaining labels;
application of hot melt adhesive bands on the side of the label facing the container, in correspondence, respectively, of the leading edge and of the trailing edge of the label in MD, said adhesive bands being parallel to the vertical axis of the container, the container having a convex lateral surface and a circular horizontal section with a diameter variable along the vertical axis,
application of the adhesivized label on the convex lateral surface of the container having a curvature radius greater than 74 mm in the correspondence of the zone wherein the upper edge of the label is applied, and greater than 72 mm in the correspondence of the zone wherein the lower edge of the label is applied; the label height, determined along the vertical axis of the container being 60 mm and the distance between the lower edge of the label and the base of the container being 12-14 mm, the hot-melt adhesive being activated by means of a heat supplying device;
label heat shrinking by passing the labelled container in a heat shrink tunnel at a temperature from 60° C. to 300° C., obtaining an adherent labelling to the container that conforms to the convex lateral surface of the container;
the label application line working at a speed from 8,000 up to 75,000 containers/hour.
